(19) United States
(12) Patent Application Publication
(10) Pub. No.: US 2006/0282313 A1
(43) Pub. Date: Dec. 14, 2006

(54) Method and apparatus for directory advertising

(76) Inventor: Michael D. Hammer, San Diego, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/150,517

(22) Filed: Jun. 9, 2005

(51) Int. Cl. G06Q 30/00

(52) U.S. Cl. 705/14

(57) ABSTRACT

A method and apparatus for telephone based directory advertising. The device features a telephone directory for advertisers that employs the advertiser's business card as the artwork for business card dimensioned advertisements. Customer retention and response is enhanced by the employment of grid lined maps. Geographic designators are situated adjacent to each business card advertisement which relate to specific locations on the maps. Customization by the user is provided for through the provision of pages adapted to engage and hold customer retained business cards thereby encouraging retention of the directory.

### FIELD OF THE INVENTION

The invention herein disclosed and described relates to advertising. More particularly it relates to what is commonly known as yellow page or telephone based directory advertising wherein subscribing advertisers place advertisements in a book of advertisers seeking sales from consumers. Such advertising generally centers upon the advertising vendor's phone number with their products categorized under industry standard headings.

### BACKGROUND OF THE INVENTION

Directory advertising, once the sole purview of the telephone companies, has in recent years been broadened as to providers of the directories. As a general rule, in placing an advertisement, subscribing retailer and vendor advertisers have been required to choose an advertisement's size, style and merchandise classification. Upon accomplishment of those primary tasks, the subscribing advertiser then is required to draft the copy for the advertisement so that the printer can at some distant date in the year print the advertisement in a bound book of similarly configured advertisements. The book is then distributed to consumers for a determined time period which has conventionally been a year.

This long time period has generally been required because of the extreme amount of time and effort which is required to draft the copy for advertisements, set the pages of the drafted copy in the chosen advertisement sizes, and then print the book itself once the thousands of advertisements have been typeset and sorted.

Vendors left out of advertising in a book of a certain geographic area of book distribution are generally out of luck until the next printing of the book covering that area. This can be over a year's time if the book in that geographic area has only recently been printed and distributed.

For new vendors entering this advertising arena where consumers increasingly key their purchase inquires off of telephone numbers, such a delay can be very costly if not catastrophic. Further, when new vendors must draft an advertisement from scratch and choose an ad size, or when current advertisers wish to change copy or ad placement, the task can be daunting at best. Such a new ad or an ad change, as noted above must follow the time-honored process of choosing the appropriate ad size, figuring out the best copy for the ad size, figuring out the placement of the copy inside the designated advertisement parameters, and then waiting for the book publisher to typeset and print the advertisement in the next issue. If a mistake on copy in the ad is made anywhere along this tedious process, especially by the publisher, the mistake remains in place for the next year of publication. Since publishers do the typesetting and are known to frequently make errors in the telephone numbers, addresses, and ad copy, which are typeset in the final published ad, the majority of the source of errors and time lost in publication preparation are caused by the tedious process required for such advertising publications.

Additionally, even when the advertisements circumnavigate the time consuming drafting and printing process without significant error or loss of time, there is a major flaw in the final product. Most such advertisements in published books and yellow pages provide the potential customer with a phone number. If the customer is lucky, an address might be provided. To residents of the geographic area of the advertisements unfamiliar with the address or streets of the area such information is virtually worthless in finding the vendor running the ad. Even long time residents of the area in which the book is published can have problems since new streets and shopping centers are frequently being added which will be unfamiliar to their knowledge of the community.

As such, there is an unmet need for a telephone number-based advertising system and apparatus which will allow for shortened publication wait times for new advertisers, and which will lessen the burden on current advertisers when copy about their business needs to be changed. Even more important, the produced advertisement should eliminate the disconnect between the published advertisement keying on the phone number but failing to provide sufficient information to potential customers on the actual location of the advertising vendor. This disconnect creates an undue burden on both the consumer and advertiser if the consumer wishes to visit the advertiser's store because they must telephone and get directions to the vendor's physical location. A busy phone line at the sought after vendor in such a scenario equates to lost customers who simply call another vendor for the same product because they need directions to the store. Finally, such directories should allow for the addition of user-collected business cards and map coordinates so they can be encouraged to use the directory long term.

As such, there exists a need for a method and apparatus which will provide for easier production of telephone directory advertising. Such a method and device should provide the subscribers to the advertising an easy manner in which to provide the copy to promote their business. Such a manner and device should also reduce the lead time required to actually produce the directory and the amount of personnel required by the directory producer to do so. Still further such a device and method should not only provide standardized information for the subscribing advertisers to their customers, it should also provide an easy manner for the customers to locate and visit the advertiser's business without the need to contact the advertiser. Additionally, such a device and method should provide for user customization to thereby encourage continued use of the directory by the users who come to depend on it for their favorite vendors and the maps to lead them to those vendors without the need to contact them.

With respect to the above description, before explaining at least one preferred embodiment of the invention in detail, it is to be understood that the invention is not limited in its application to the details of construction and to the arrangement of the apparatus produced and/or steps set forth in the following description or illustrated in the drawings. The various apparatus and methods of the invention herein described and disclosed, are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception, upon which this disclosure is based, may readily be utilized as a basis for designing of other devices, methods and systems for carrying out the several purposes of the present disclosed device. It is important, therefore, that the objects and claims be regarded as including such equivalent construction and methodology insofar as they do not depart from the spirit and scope of the present invention.

Further objectives of this invention will be brought out in the following part of the specification, wherein detailed description is for the purpose of fully disclosing the invention without placing limitations thereon.

### SUMMARY OF THE INVENTION

The device herein disclosed and described features an apparatus in the form of a directory advertising book that overcomes the shortcomings of previous such directories in both the ability to inform the customer of the advertiser's location and in reduction of time required to produce the ads and book itself.

Using the method of operation herein outlined, directory advertising book production is streamlined by standardizing the advertisements to business card dimensions and using a currently printed business card of a subscribing advertiser to provide the copy for the eventually printed advertisement.

Since businesses generally take great pains to produce accurate and attractive business cards, using those cards for the copy on a printed advertisement saves the subscribing advertiser the time normally required to pick an advertisement size and then produce copy in the chosen size that accurately describe their products or services. Further, by allowing the publisher to use the business cards as the approved copy for the advertisement, there is no need for the publisher to typeset the advertiser-supplied copy in the proper size and format. Elimination of this step not only speeds up the production of the eventual directory, it eliminates the common typographical errors that happen when subscribers rely on typesetters to draft their advertisements. The result is a visually appealing directory for advertisers. Additionally, the produced product can be handled in a fraction of the time of conventional directory advertising books thereby allowing for possible multiple editions annually. As noted above, a further benefit occurs with new businesses placing their advertising for the first time. Since they need only provide a business card to the publisher, deadlines which might have been missed in the past due to artwork and copy drafting are eliminated.

Further, the produced device provides a unique geographic designator adjacent to each advertisement that provides users the ability to discern an advertiser's location in a town or city without the need to contact the vendor and without the need to consult a separate map or guide. Immediately adjacent to each printed business card-sized advertisement will be indicia providing a location on a map that is provided elsewhere in the directory. The maps provided will have vertical and horizontal designators thereon that allow the user to read the advertisement, and the adjacent indicia, and immediately locate the advertiser's place of business on a map.

The indicia and maps provided may also be color coded to make it easier for customers to find the proper map section where the indicia indicates the advertiser resides. As noted this eliminates the lost customer who might have failed to contact the vendor due to phone problems and who can simply go to the advertiser's place of business without the need to call for directions.

Still further, in another preferred embodiment of the device, separate pages are provided which are adapted to engage with and hold business cards that the user or customer wishes to add to the directory. These pages would provide a means to attach the business card to a position on the page adjacent to an indicia box positioned for the user to enter grid coordinates. In this fashion, customers are encouraged to use the published directory as a guide to all their purchasing since they may add additional business card sized ads themselves to the directory for future use. The pages provided for engagement of the user-collected business cards can either be a separate page providing for multiple cards on that page, or, designated boxes or positions in each of the directory's sections may be provided so that a user may add the card of a favorite vendor to the correct section of the directory for that vendor's products.

For example, one or a plurality of positions may be provided in the “florist” section of the directory on one or more pages. The positions would provide a means to attach a user-collected business card to that section and to hand write the map coordinates adjacent to the added card. In this fashion, the user adds the card of his favorite florist to the directory and such a provision encourages the users to keep the directories as personal guides and use them more than just a standard directory which has no user-added provisions.

Finally, to further facilitate customization and to eliminate the need to contact vendors for map directions, the directory can be provided with the ability to get map coordinates based on the vendor's phone number. This would be enabled by allowing the user to call a provided telephone number printed in the directory whereafter they would enter the vendor's phone number and the map coordinates would be provided by a computer and electronic voice capability or a human interface.

As a method the steps employed to produce assembled directories would include the steps of:

(A contacting potential advertisers;

(B) securing their business card for reproduction in the proper designated section of the directory;

(C) determining the desired filtering, pressure compensation, and backflow characteristics desired in the assembled emitter;

(D) assembling the total collected business cards from advertisers and reproducing them in a bound directory in the correct product or service sections of the directory;

(E) providing indicia adjacent to each reproduced business card in the directory which relates to an exact position on a map also provided in the directory; and

(F) distributing the produced directory to potential customers of the subscribing advertisers and the geographic area shown on the map and adjacent to the map in the directory.

In an additionally preferred mode of the device, the extra steps of:

(G) providing pages in the produced directory adapted to engage business cards thereon in designated individual positions;

(H) providing indicia locations adjacent to each respective designated individual position for business cards to allow the user to write map coordinates for that added card which designate the geographic location of the business in the added card on the map produced in the directory.

Optionally, to further enhance usability and encourage customization which encourages use, the directory can:

(I) provide a telephone number to call and enter a vendor's phone number to receive map coordinates that can be entered by the user on the map in a designated box next to the user inserted business card.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and method shown and described herein, and accordingly, all suitable modifications and equivalents which may be resorted to, shall fall within the scope of the invention.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

It is an object of the present invention to provide a method of production of a directory of advertisers with phone numbers, which reduces the time required by the publisher to print.

It is another object of this invention to provide users and potential customers of the advertisers in the directory the ability to locate the advertiser without the need to refer to any other source but the directory itself.

It is a further object of this invention to provide geographic locators adjacent to each advertiser's ad, which allow the user to easily find the physical location of that advertiser on a directory encompassed map.

It yet an additional object of this invention to allow users to add the business cards of vendors they prefer to the produced directory by providing pages adapted to engage and retain business cards.

It is a still further object of this invention to encourage the constant and continual use of the produced directory by customers by allowing the engagement of additional user desirable business cards and providing positions adjacent to the added cards for users to enter map coordinates identifying the location of the added vendor on the map already included in the directory and providing telephonic means to ascertain those coordinates.

The foregoing has outlined some of the more pertinent objects of the invention. These objects should be construed to be merely illustrative of some of the more prominent features and applications of the intended invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings wherein the detailed description is for the purpose of fully disclosing the invention without placing limitations thereon.

### BRIEF DESCRIPTION OF THE FIGURES

FIG. 1 depicts a page of the produced directory showing business card generated advertiser ads immediately adjacent to location indicia designating the geographic location of that advertiser on an included map.

FIG. 2 depicts a map having vertical and horizontal designators relating to the location indicia adjacent to the advertisements in the directory.

FIG. 3 depicts a page in the directory which is adapted for user engagement of user-collected business cards and has positions designated adjacent to the engagement point for user written location indicia.

FIG. 4 shows a page in the directory wherein a single position is provided and adapted for engagement with a user-collected business card to allow the collection and retention of favored vendors by category of service or product.

### DETAILED DESCRIPTION OF THE PREFERRED EMBODIMENTS OF THE INVENTION

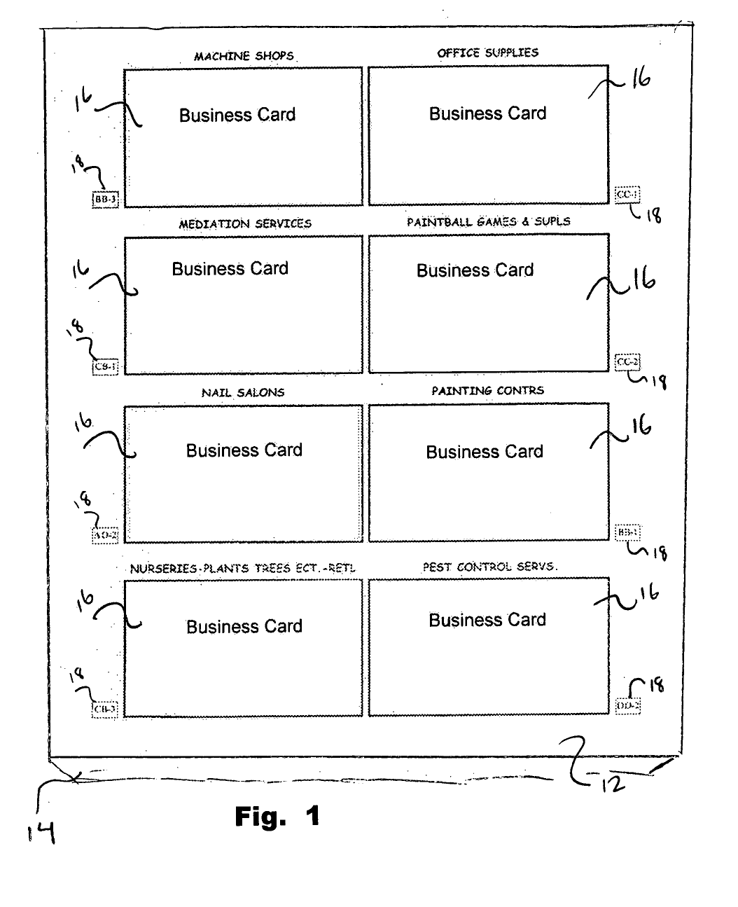

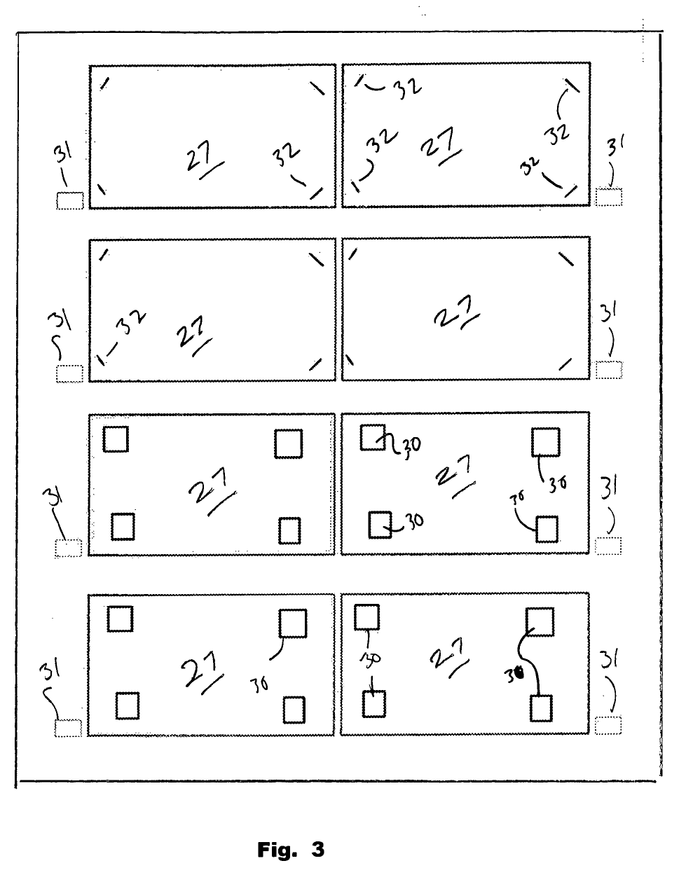

Referring now to the drawings, FIGS. 1-4 depict the various preferred embodiments of the device and method herein disclosed and describe.

In FIG. 1 there is shown a typical page 12 of the produced directory 14 showing business card generated advertiser ads 16 printed on the page 12 in an orderly fashion. Adjacent and relating to each ad 16 is provided location indicia 18 which relates to a specific geographic location of the advertiser in the ad 16. This geographic location is easily found by employing the location indicia 18 and referencing it to one or a plurality of maps 20 also printed in the directory 14.

The location indicia 18 adjacent to each ad 16 designates an exact position on a map 20 using vertical and horizontal designators on the map 20. The location indicia 18 will generally also carry a page designator 21 in the form of a letter or number which allows the user to easily find the page of the directory 14 where the map 20 required for the specific location indicia, 18 relating to a specific ad 16 is located. This provision of location indicia 18 allows the user to easily locate and visit the advertiser in the adjacent ad 16 without the need to refer to any other book or directory and without the need to contact the advertiser by phone as would be the case with conventional directories. The user can do so by simply using the information in the location indicia 18 to identify the map 20 and exact position on the map 20 where the advertiser is located.

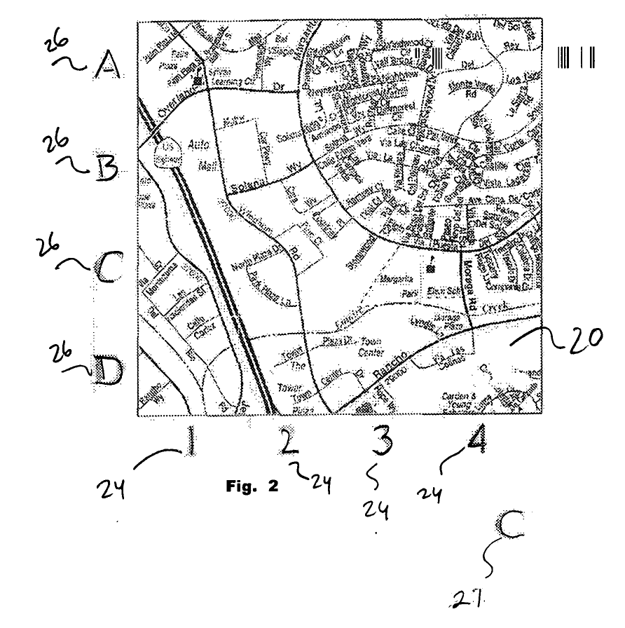

As shown in FIG. 2 the map 20 has vertical designators 24 and horizontal designators 26 which relate to the information in the location indicia 18 adjacent to each ad 16. The user can simply read the identification indicia 18 adjacent to the ad 16 for a desired vendor or advertiser and locate their position on the map 20 as the crossing point of lines running from the vertical designator 24 and horizontal designator 26. The Identification indicia 18 adjacent to the ad for each vendor would carry the proper information for both the horizontal and vertical starting points.

Additionally, it is preferred that the location indicia 18 also provide a page designator of the page or pages in the directory where maps 20 are located. This could either be a number or a letter, or in some cases with multiple maps 20 or multiple zones on a map 20, a color designator showing a section of the map 20 where the business is located making it easier to follow the horizontal and vertical designators to the advertiser's location.

An especially preferred component of one embodiment of the device 10 would the inclusion of positions 27 on a page 12 adapted for engagement of a user provided business card 28. Means for engagement of the business card 28 to the page 12 would be provided in the form of adhesive 30, slots 32 formed in, or placed on the page 12. Of course other means for attachment of a business card 28 to the page 12 would occur to those skilled in the art and such are anticipated.

Adjacent to each provided user engageable position 27 for a user provided business card would be a user filled position 31 for location indicia 18. The user would as noted above be able to insert a favored vendor's business card onto the appropriate page 12 and have it stay in an attached position. Then the user would be able to enter with a pen or pencil the location indicia 18 at the user filled position 31 by finding the horizontal and vertical designators relating to the position of the favored vendor.

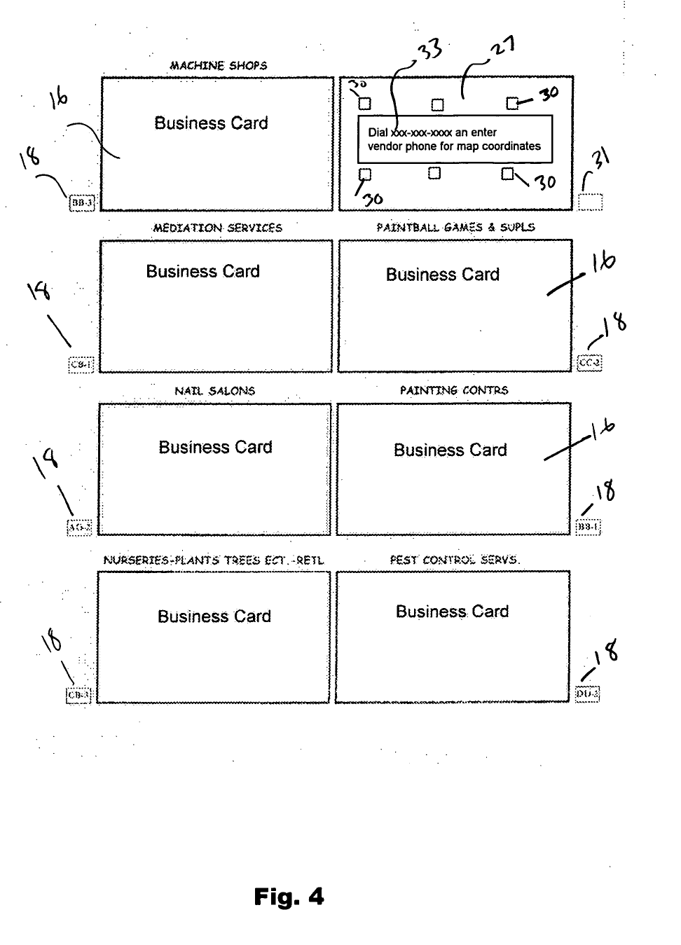

This ability to include the user's favored vendors' business cards 18 in the directory 14 helps insure that the user would retain the directory 14 for a long duration as the user would tend to hold onto a directory 14 with information personal to that user. As noted, above, the engageable positions 27 for the user to adhere their collected business cards 28 may be on a page specifically for that purpose, or as shown in FIG. 4, in engageable positions 27 provided in the various categories of products and services printed in the directory 14. This allows the user to either locate all of the collected cards 28 on one page 12 by favorites, or on pages where the business cards 28 can be found by category of service or product, depending on the user's personal preference.

Still further, in the event that the user needs help in determining the map coordinates for a user-added vendor business card for the user filled position 31, without the need to contact the vendor, a means for telephonic determination of the map coordinates can be provided. This would be done by providing a contact telephone number 33 which would best be printed in or adjacent to user engageable positions 27 for user favored business cards. The user would call the telephone number 33 and then input or orally provide the telephone number of the vendor on the business card they are adding to the engageable position 27. The map coordinates which relate to the map 20 would be provided to the user for entry into the user filled position 31. In this fashion the user would still not have to contact the vendor to ascertain their location which greatly reduces vendor telephone calls for directions and lost business if the call cannot be answered or if the person answering is direction-challenged.

The telephone number 33 provided would be best answered by a computer which would cue the user to enter the phone number of the vendor on the card they are adding. This can be done by pressing the telephone keys or orally. The computer would then look up the address and map coordinates for that vendor based on the provided phone number which would be stored in the computer database of telephone numbers cross referenced with business addresses and map coordinates on a national basis. The computer can use a synthesized voice to relay the map location, or a human might be provided to do the same. However, the computer would be preferable for speed. Once the map location is provided to the user, they can enter it into the user filled position 31 provided adjacent to the user engageable position 27. Such a degree of customization and accuracy encourages the user to keep and carry the directory and refer to it frequently.

Although the invention has been herein disclosed and described with respect to particular embodiments thereof, it should be realized that various changes and modifications may be made therein without departing from the spirit and scope of the invention. While the invention as shown in the drawings and described in detail herein discloses arrangements of elements of particular construction and configuration for illustrating preferred embodiments of structure and method of operation of the present invention, it is to be understood, however, that elements of different construction and configuration and other arrangements thereof, other than those illustrated and described, may be employed in accordance with the spirit of this invention. Any and all such changes, alternations and modifications as would occur to those skilled in the art are considered to be within the scope of this invention as broadly defined in the appended claims.

Further, the purpose of the attached abstract is to enable the U.S. Patent and Trademark Office and the public generally, and especially the scientists, engineers and practitioners in the art who are not familiar with patent or legal terms or phraseology to determine quickly from a cursory inspection the nature and essence of the technical disclosure of the application. The abstract is neither intended to define the invention of the application, which is measured by the claims, nor is it intended to be limiting as to the scope of the invention in any way.

What is claimed is:

1. A method for providing users an advertising directory by:
reproduction of subscribing advertisers to said directory, comprising the steps of:
(a) securing images of a business cards from each respective subscribing advertiser to said directory;
(b) reproducing said images in said directory in directory sections categorized by the goods or services provided by each of said respective subscribing advertisers;
(c) providing at least one map in said directory;
(d) providing location indicia adjacent to each said image in the directory, said location indicia identifying on said map a physical location of said subscribing advertiser in said image adjacent to said location indicia; and
(e) distributing the produced directory to potential customers for said subscribing advertisers, whereby said customers may ascertain said goods or services of each said respective subscribing advertiser from said image of said business card reproduced in said directory and may determine an exact location of any of said subscribing advertisers on said maps provided in said directory, using said location indicia, without contacting said subscribing advertiser.

2. The method for providing users an advertising directory of claim 1 comprising the additional steps of:
providing pages said directory adapted to engage business cards of user-added vendors at mounting positions thereon, whereby said user may attach a business card of a user-added vendor, in said mounting positions; and
providing an indicia notation location, adjacent to each respective mounting position, for said user to place said location indicia for said user-added vendor, whereby said user may engage said business card to said directory and place said location indicia adjacent to said business card in said indicia notation location.

3. The method for providing users an advertising directory of claim 1 comprising the additional steps of:
providing mounting positions within said sections of said directory, said mounting positions adapted to engage a business card from a user-added vendor, whereby said business cards of said user-added vendors may be engaged to said directory to said mounting positions within said sections categorized by the goods or services provided by said user-added vendors.

4. The method for providing users an advertising directory of claim 2 comprising the additional steps of:
providing secondary mounting positions for said business cards in said directory within said categorized sections, whereby said business cards of said user-added vendors may engaged to said directory to said secondary mounting positions within said categorized section related to the goods or services provided by said user-added vendors; and
providing one said indicia notation location, adjacent to each respective secondary mounting position, for said user to place said location indicia for said user-added vendor, whereby said user may engage said business card to said directory at said mounting positions or said secondary mounting positions and place said location indicia adjacent to said business card in said indicia notation location.

5. The method for providing users an advertising directory of claim 2 comprising the additional steps of:
providing a telephone number to call and communicate a user-added vendor's telephone phone number; and
in response to said vendor's telephone number, communicating to said user, said location indicia for said user-added vendor, whereby said user may place said location indicia in said notation location adjacent to said mounting position where said business card of said user-added vendor is attached.

6. The method for providing users an advertising directory of claim 3 comprising the additional steps of:
providing a telephone number to call and communicate a user-added vendor's telephone phone number; and
in response to said vendor's telephone number, communicating to said user, said location indicia for said user-added vendor, whereby said user may place said location indicia in said notation location adjacent to said mounting position where said business card of said user-added vendor is attached.

7. The method for providing users an advertising directory of claim 4 comprising the additional steps of:
providing a telephone number to call and communicate a user-added vendor's telephone phone number; and
in response to communication of said user-added vendor's telephone number, communicating to said user, said location indicia of said user-added vendor, whereby said user may place said location indicia of said user-added vendor in said notation location adjacent to said mounting position or said secondary mounting position, where said business card of said user-added vendor is attached.

8. The method for providing users an advertising directory of claim 5 comprising the additional steps of:
designating said mounting positions by providing indicia in the form of a box having an area substantially the size of a business card; and
printing said telephone number within said box.

9. The method for providing users an advertising directory of claim 6 comprising the additional steps of:
designating said mounting positions by providing indicia in the form of a box having an area substantially the size of a business card; and
printing said telephone number within said box.

10. The method for providing users an advertising directory of claim 7 comprising the additional steps of:
designating said mounting positions and said secondary mounting positions by providing indicia in the form of a box having an area substantially the size of a business card; and
printing said telephone number within said box.

11. A an advertising directory comprising:
a plurality of advertising pages;
each said advertising page having business cards of subscribing advertisers reproduced in advertisements thereon;
at least one map representing the geographic area occupied by said subscribing advertisers, said map reproduced on a map page of said advertising directory; and
location indicia reproduced adjacent to each said advertisement, said location indicia identifying a physical location on said map, of said subscribing advertiser represented each respective said advertisement, whereby customers may ascertain said goods or services of each said respective subscribing advertiser from said image of said business card reproduced in said advertisement and may determine an exact location of any of said subscribing advertisers on said map provided in said directory, using said location indicia, without contacting said subscribing advertiser.

12. The advertising directory of claim 11 additionally comprising:
said advertising pages categorized by sections defined by the goods or services provided by said subscribing advertisers displayed in said sections.

13. The advertising directory of claim 11 additionally comprising:
at least one page in said directory adapted to engage business cards of user-added vendors at mounting positions thereon, whereby said user may attach a business card of a user-added vendor, in said mounting positions; and
an indicia notation location, said indicia notation location positioned adjacent to each respective mounting position, whereby said user can engage said business card to said directory and place said location indicia adjacent to said business card in said indicia notation location.

14. The advertising directory of claim 12 additionally comprising:
at least one page in said directory adapted to engage business cards of user-added vendors at mounting positions thereon, whereby said user may attach a business card of a user-added vendor, in said mounting positions; and
an indicia notation location, said indicia notation location positioned adjacent to each respective mounting position, whereby said user can engage said business card to said directory and place said location indicia adjacent to said business card in said indicia notation location.

15. The advertising directory of claim 12 additionally comprising:
secondary mounting positions within said sections of said directory, said secondary mounting positions adapted to engage a business card from a user-added vendor, whereby said business cards of said user-added vendors may be engaged to said directory to said mounting positions within said sections categorized by the goods or services provided by said user-added vendors.

16. The advertising directory of claim 14 additionally comprising:
secondary mounting positions within said sections of said directory, said secondary mounting positions adapted to engage a business card from a user-added vendor, whereby said business cards of said user-added vendors may be engaged to said directory to said mounting positions within said sections categorized by the goods or
services provided by said user-added vendors.

17. The advertising directory of claim 13 additionally comprising:
a communication telephone number printed in said advertising directory, said communication telephone number employable by said user to call and communicate a user-added vendor's telephone phone number; and
means to provide a response to said vendor's telephone number communicated to said communication telephone number, said response providing said location indicia for said user-added vendor, whereby said user can place said location indicia in said notation location adjacent to said mounting position where said business card of said user-added vendor is attached.

18. The advertising directory of claim 14 additionally comprising:
a communication telephone number printed in said advertising directory, said communication telephone number employable by said user to call and communicate a user-added vendor's telephone phone number; and
means to provide a response to said vendor's telephone number communicated to said communication telephone number, said response providing said location indicia for said user-added vendor, whereby said user can place said location indicia in said notation location adjacent to said mounting position where said business card of said user-added vendor is attached.

19. The advertising directory of claim 15 additionally comprising:
a communication telephone number printed in said advertising directory, said communication telephone number employable by said user to call and communicate a user-added vendor's telephone phone number; and
means to provide a response to said vendor's telephone number communicated to said communication telephone number, said response providing said location indicia for said user-added vendor, whereby said user can place said location indicia in said notation location adjacent to said mounting position or said secondary mounting position where said business card of said user-added vendor is attached.

20. The advertising directory of claim 16 additionally comprising:
a communication telephone number printed in said advertising directory, said communication telephone number employable by said user to call and communicate a user-added vendor's telephone phone number; and
means to provide a response to said vendor's telephone number communicated to said communication telephone number, said response providing said location indicia for said user-added vendor, whereby said user can place said location indicia in said notation location adjacent to said mounting position or said secondary mounting position where said business card of said user-added vendor is attached.
